(19) United States
(12) Patent Application Publication
(10) Pub. No.: US 2012/0145640 A1
(43) Pub. Date: Jun. 14, 2012

(54) METHOD AND COMPOSITION TO REDUCE THE AMOUNTS OF HEAVY METAL IN AQUEOUS SOLUTION

(76) Inventors: Arden D. DAVIS, Rapid City, SD (US); Cathleen J. Webb, Bowling Green, KY (US); Jenifer Sorensen, Rapid City, SD (US); Terrence E. Williamson, Rapid City, SD (US); David J. Dixon, Rapid City, SD (US)

(21) Appl. No.: 13/274,140

(22) Filed: Oct. 14, 2011

Related U.S. Application Data
(60) Provisional application No. 61/393,806, filed on Oct. 15, 2010.

(51) Int. Cl. C02F 1/62; C02F 1/64; B01J 20/04; C01F 11/18; C09K 3/00; B01J 20/02; B01D 15/04; C01B 31/00

(52) U.S. Cl. 210/688; 210/681; 423/419.1; 423/430; 252/184; 502/400

(57) ABSTRACT

The present invention relates to a method for removing heavy metals from aqueous solutions by contacting heavy metal-contaminated water with a sorption media, or in particular with carbonate minerals. The present invention also relates to methods of using modified sorption media, such as aggregates of carbonate minerals and modified carbonate minerals, for the removal of heavy metals.

### CROSS-REFERENCE TO RELATED APPLICATION

The present application claims priority to provisional patent application Ser. No. 61/393,806, filed Oct. 15, 2010, entitled “Method and Composition to Reduce the Amounts of Heavy Metal in Water,” which is incorporated by reference into the present application as if set forth verbatim.

### FIELD OF THE INVENTION

The present invention relates to a method for removing heavy metal in heavy metal contaminated water, especially for small drinking water systems such as these used in individual homes, rural areas, and small communities, by simply contacting heavy metal contaminated water with a sorption media. The present invention also relates to the composition of the sorption media which comprises calcium carbonate mineral particles and magnesium carbonate aggregates.

### BACKGROUND OF THE INVENTION

Heavy metals retention and mobility in surface water and ground water are of great concern because of their toxic effects on the environment. A particular concern is the presence of heavy metals in mine runoff. Current remediation technologies are expensive and have additional disposal problems to contend with. This has led to abandonment of many mining sites, rather than remediation. There is also a need to purify and remove heavy metal contaminants from ground water and drinking water.

Small, or even trace amounts of certain heavy metals can have deleterious health effects and can be toxic. Children are particularly susceptible to such trace amounts in drinking water. The drinking water standard for cadmium is 5 parts per billion (ppb), and it is implicated in kidney damage and outbreaks of disease that result in softening of the bones. The drinking water standard for lead is 15 ppb, and lead is toxic to the nervous system, blood, liver, heart and reproductive organs.

Current technologies that are commonly considered for reduction or removal of heavy metals in water include caustic soda treatment, lime treatment and modified sulfide treatment processes. Other approaches include artificial wetlands and cattle waste. While these technologies have been shown to reduce some of the heavy metals, they are often expensive and produce large amounts of sludge that have to be disposed. For example, results of California Waste Extraction Tests at Iron Mountain, near Redding, Calif. indicates that cadmium and zinc concentrations did not meet the requirements in the sludge from caustic soda treatment and a modified lime/sulfide process. The common issue for mining and industrial situations is the high cost, the need for well-trained operators, and the difficulty in maintaining optimum operating conditions.

It is desirable to make use of a system for removing heavy metals that is robust and inexpensive to deploy and manage. It is desirable to be able to treat large volumes of water quickly and efficiently, and should result in a relatively small amount and compact amount of heavy metals on the heavy metal removal media. It should be compatible with existing water treatment systems, should not require the addition of chemicals to adjust pH, and the by-products of the process should not require further disposal as hazardous material. The system and processes should be easy to operate by personnel and easy to maintain. It is desirable that such a system should relatively portable or otherwise easy to set up and should be adaptable to a variety of field conditions. It is also desirable that the system is capable of contaminant removal at the source of the water.

The present invention provides a safe and inexpensive, mineral-based heavy metal removal media to remove and lock away heavy metals from water. The system can be adapted to mining and other industrial locations to purify water, as well as commonly accessible ground water sources and aquifers. The system can be used to purify water to meet water quality standards for environmental protection. The system has the benefits of using readily available and low cost materials, and can process large volumes of water quickly and efficiently. The hazardous metals are captured in a relatively small and compact amount in a stable and benign waste product that can be discarded in ordinary landfills or used in concrete. The system can be readily portable and easy to set up, so it can be adapted to a variety of field conditions and used for point source reduction of contaminants. The system can be readily designed for use in individual homes, rural areas, and in small communities, as well as for industrial uses, and remediation of mining or Superfund sites.

Current heavy metal remediation technologies are relatively expensive, require substantial technical equipment and trained personnel to achieve significant reductions in heavy metal levels, and are generally unsuitable for individual users, rural communities, or relatively smaller water systems. Lowering the federal water standard for heavy metal will place significantly increased socio-economic pressures on those water systems that will be required to meet lower standards for allowable or acceptable amounts of heavy metal.

Toxic metals found in water that can be very harmful to the environment and animal health. In particular, there is growing awareness of heavy metal contamination in drinking water. Severe effects include reduced growth and development, cancer, organ damage, nervous system damage, and in extreme cases, death. Exposure to some metals, such as mercury and lead, may also cause development of autoimmunity, which can lead to joint diseases such as rheumatoid arthritis, and diseases of the kidneys, circulatory system, and nervous system. Childhood exposure to some metals can result in learning difficulties, memory impairment, damage to the nervous system, and behavioral problems such as aggressiveness and hyperactivity. At higher doses, heavy metals can cause irreversible brain damage.

Toxic metals can be present in industrial, municipal, and urban runoff, which can be harmful to humans and aquatic life. Increased urbanization and industrialization have resulted in increased levels of trace metals, especially heavy metals, in our waterways. Heavy metals in the environment are caused by air emissions from coal-burning plants, smelters, and other industrial facilities; waste incinerators; process wastes from mining and industry; and lead in household plumbing and old house paints. Once released to the environment, metals can remain for decades or centuries, increasing the likelihood of human exposure. There are growing concerns of the presence of trace metals in tap and well water. Toxic chemicals and heavy metals routinely penetrate and pollute our natural water sources. Most sources of our drinking water, including municipal water systems, wells, lakes, rivers, and even glaciers, contain some level of contamination.

There are over 50 elements that can be classified as heavy metals, 17 of which are considered to be both very toxic and relatively accessible. Toxicity levels depend on the type of metal, its biological role, and the type of organisms that are exposed to it. The heavy metals linked most often to human poisoning are lead, mercury, and cadmium. Other heavy metals, including copper, zinc, and chromium, are actually required by the body in small amounts, but can also be toxic in larger doses. The effects of these metals on human health is well documented.

The need for a low-cost, efficient heavy metal removal system for such water systems is not unique to the United States. In many places throughout the world, excessive heavy metal in potable water is a critical health issue, regardless of existing or non-existing regulations. The World Health Organization has compiled reports of relatively high levels of heavy metal in drinking water in many countries, including Mexico, China, and Bangladesh.

Current remediation technologies commonly considered for removal or reduction of the amounts of heavy metal in potable water include ion exchange, coagulation and filtration, activated alumina, lime softening, various iron based medium, and reverse osmosis. Each of these has significant shortcomings. For example, ion-exchange technology currently is used to remove or reduce the amounts of certain contaminants, including heavy metal, in water. The removal of heavy metal using this technology is based on the charge-charge interaction and thus it is not selective. Anionic ion-exchange resins remove not only heavy metal but also other contaminants such as sulfate, selenium, fluoride, and nitrate. Also, suspended solids and iron precipitation can clog the system. In any event, an ion-exchange system must eventually be regenerated, typically by flushing with brine. This results in a concentrated brine solution containing high levels of heavy metal and other contaminants, which in turn creates a waste disposal issue. Further an ion-exchange system does not provide an indication of the level of heavy metal in the bed or of the bed being saturated with heavy metal. Moreover, an ion-exchange system is too expensive, inefficient, and complex for use in smaller water systems or as an end-use application such as a home, farm, business, or individual well.

Coagulation and filtration is a batch process involving segregating a fixed amount of heavy metal-contaminated water into a tank, adding iron to coagulate the heavy metal, and filtering the batch to remove the coagulated heavy metal. This process requires significant capital equipment and trained personnel, and is most efficient at a mid-range pH. As a non-continuous process that is relatively expensive and complex, coagulation and filtration also is unsuitable for smaller water systems or as an end use application.

Lime softening is a process in which highly trained personnel adjust the pH of the heavy metal-contaminated water to a relatively high pH, which facilitates the adsorption of heavy metal onto larger particles, such as iron hydroxide, and then reduces the remaining water to a potable pH level. As with the ion-exchange and the coagulation and filtration technologies, lime softening creates a waste product that results in disposal issues, is relatively expensive, requires trained personnel to operate the equipment, and is not a continuous process.

Activated alumina, reverse osmosis, and a variety of other technologies utilizing iron-based medium are other processes that are currently considered for removal or reduction of heavy metal in drinking water. Activated alumina requires significant technical intervention and processing, making it impractical for all but larger water systems. Reverse osmosis is not an effective process for this purpose because up to 80 to 90% of the water is discarded. Iron-based media generally involve the use or iron oxide, e.g., sand coated with rust, to attract, remove, and hold heavy metal from the water. These processes generally have significant problems with capacity, water, quality, efficiency, and waste disposal. Although having a high capacity for heavy metal, granulated ferric hydroxides (“GFH”) are extremely expensive and must be disposed of in a certified landfill or recycled industrially. Additionally, granulated ferric hydroxides require substantial technical oversight and are unsuitable for rural and small public water supply systems.

Use of the processes and materials described herein for removal of various heavy metals from water provide many desirable benefits. One of the key advantages is the relative low cost and ready availability of the materials and processes. For example, the heavy metal removal media, such as limestone, is in mineral form and are generally available in bulk at very low cost. The processes have applicability over a wide range of geographic conditions and for a variety of different water systems. The processes can be readily adapted to a variety of water-quality conditions. The processes and materials allow for heavy metal remediation of water at the point of entry, thereby providing easy and efficient access to community-wide filtration of water sources. The processes and materials can provide efficient treatment of water at rural public water systems or in individual households. In addition, the heavy metals can be safely removed, and the resultant waste material can be safely and inexpensively disposed in a landfill or incorporated into cement or concrete as aggregate.

Therefore a need exists for a method and composition to reduce the amounts of heavy metal in heavy metal-contaminated water, particularly with less expense, less complexity, less personnel requirements, and less waste disposal issues. With heavy metal levels in drinking water increasingly becoming a health concern in the United States and elsewhere, and with a possible significant reduction in the federal water standard for heavy metal in drinking water, this need is particularly acute for home, individual, rural, and relatively smaller drinking water systems.

### SUMMARY OF THE INVENTION

The present invention is directed to a method for removal of heavy metal contaminants from aqueous solutions. The contaminated aqueous solution, such as ground water, waste water or water run-offs is contacted with a sorption media resulting in sorption of the heavy metals by the sorption media. Removal or separation of the sorption media from the aqueous solution results in a decrease in the concentration of the heavy metal contaminants in the aqueous solution. The method of the present invention is especially suitable for small drinking water systems, such as those used in individual homes, rural areas, and small communities. The resultant media with the sorbed heavy metals can be safely disposed of or reused as filler in a concrete aggregate.

The present invention is also directed to a composition of a sorption media that can sorb heavy metals from an aqueous solution. The sorption media is composed of carbonate particles with a sufficient surface area to interact with heavy metal species in solution for efficient heavy metal removal from heavy metal-contaminated or contained solution. Efficient heavy metal removal generally is substantial removal of heavy metals over an extended period of time. The amount of heavy metals considered “substantial” and amount of time considered “extended” depends upon the particular application or use for the sorption media and/or industry. The carbonate particles are preferably from minerals and are carbonate minerals or calcium carbonate minerals. In one aspect, the sorption media is composed of calcium carbonate particles, preferably from minerals such as limestones and marble. In another aspect, the sorption media also contains a binder, such as, but, not limited to, Portland cement, to form aggregates. These aggregates can be in the form of pellets or granules in applications where a flow rate is a great concern, such as filtration and column separation. In yet another aspect, the calcium carbonate particles of the sorption media are treated with water soluble magnesium salts, especially organic salts such as magnesium acetate, to form magnesium carbonate aggregates on the surfaces of those particles.

### BRIEF DESCRIPTION OF THE DRAWINGS

FIG. 1 is a schematic depicting one embodiment of an apparatus and process to reduce the amounts of heavy metal in drinking water.

FIG. 2 is a schematic depicting another embodiment of an apparatus and process to reduce the amounts of heavy metal in drinking water.

FIG. 3 is a schematic depicting another embodiment of an apparatus and process to reduce the amounts of heavy metal in drinking water.

FIG. 4 is a graph of the results of a batch test depicting the removal of lead, zinc, chromium, manganese, cadmium and selenium from water by Minnekahta limestone.

FIG. 5 is a graph of the results of a batch test depicting the removal of mercury from water by Kentucky Limestone.

FIG. 6 is a graph of the results of a batch test depicting removal of lead, zinc, chromium, manganese, cadmium and selenium from arsenic-infused water by Minnekahta limestone.

### DETAILED DESCRIPTION OF THE INVENTION

The present invention relates to a method for removing heavy metals or otherwise reducing the concentration of the heavy metals from aqueous solutions. The heavy metal-contaminated or contained solution is contacted with a sorption media. The present invention also relates to the composition of the sorption media which comprises calcium carbonate mineral particles and magnesium carbonate aggregates.

As used in this disclosure, the singular forms “a”, “an”, and “the” may refer to plural articles unless specifically stated otherwise. To facilitate understanding of the invention set forth in the disclosure that follows, a number of terms are defined below.

As used herein, the term “heavy metals” includes all chemical elements other than arsenic with a specific gravity that is at least 5 times the specific gravity of water. The specific gravity of water is 1 at 4° C. (39° F.). Heavy metals can include the divalent heavy metals. Heavy metals can include, but are not limited to, such elements as lead (Pb), zinc (Zn), chromium (Cr), manganese (Mn), cadmium (Cd) and selenium (Se). Other heavy metals include, but are not limited to: cobalt (Co), copper (Cu), iron (Fe), lead (Pb), mercury (Hg), molybdenum (Mo), nickel (Ni), tin (Sb), gold (Au), and thallium (Tl).

As used herein, the term “sorption” refers to a process where a chemical species interacts with the surface of a material or otherwise accumulates on or in the surface of the material. Sorption processes include adsorption, absorption, precipitation/dissolution and co-precipitation.

As used herein, the term “sorption media” refers to a material that reduces the amount of chemical species, such as heavy metals, in aqueous solutions, by sorption. Sorption media includes treated or untreated minerals, carbonate minerals, and calcium carbonate minerals. Untreated minerals are those in their raw or natural form, as obtained from the ground. Treated minerals include those minerals that have been modified, including, but not limited to, chemical and physical modification. The sorption media can also include agglomerated or granulated minerals. Sorption media can also include minerals where chemical additives have been added in combination with the mineral, or the mineral has otherwise been modified.

As used herein, the term “carbonate minerals” are naturally occurring chemical substances with a definite chemical structure and composition formed through geologic processes that contain the carbonate ion. Carbonate minerals includes treated and untreated minerals. Carbonate minerals can include calcium carbonates and magnesium carbonates. Other carbonates include iron, manganese, barium, lead, zinc and cadmium carbonates. Calcium carbonates found in minerals include calcite, aragonite, and vaterite. Magnesium carbonates found in minerals can include magnesite. Minerals with calcium/magnesium carbonates can include dolomite and huntite. The carbonate mineral can be found in limestone, chalk, marble, or travertine.

As used herein, the term “disposal media” is the sorption media that has sorbed chemical species associated with it. The disposal media, once removed or separated from the aqueous solution results in removal or reduction in concentration of the heavy metals from the aqueous solution. The disposal media can then be processed for proper disposal. In the case of particular heavy metals, proper disposal of the disposal media refers to procedures that conform to mandated regulatory standards.

Sorption is a process where chemical species accumulate on or in the surface of the material. These processes include adsorption, absorption, precipitation/dissolution and co-precipitation. Sorption processes are primarily a surface-related phenomena. For purposes of the present invention, it is contemplated that the chemical species that sorb onto or into the surface of the media with sufficient attraction and for sufficient duration that the chemical species can remain associated with the media. Removal or separation of the sorption media, or disposal media, from the aqueous solution then results in removal of the chemical species from the aqueous solution. This removal or separation of the sorption media from the aqueous media can be accomplished by passing the solution through a column of the media, or by filtering the media away from the solution. In either case, removal or separation of the media carries with it the chemical species that are sorbed onto the media, and the resultant media, the disposal media, can then be properly disposed off.

It is another feature of the present invention that the disposal media can be readily disposed of in a proper manner without additional processing, or without further remedial treatment. It is further contemplated that the disposal media can be directly used, without additional processing, as a bulk material agent for other applications in a form that meets the pertinent regulatory requirements. One such application is use in cement or asphalt. It is an advantage of the present invention that the disposal media does not leach the removed or sorbed contaminants, and it thereby does not pose an additional burden or threat of contamination to its surrounding environment.

The sorption material can comprise carbonate minerals, and in particular, calcium carbonate minerals. There are at least 277 carbonate minerals, and 158 of these are pure carbonates. The three most common minerals of calcium carbonate are calcite, aragonite, and dolomite. Calcite is the most stable crystal or polymorphic form of natural crystalline calcium carbonate. It is commonly found in sedimentary, igneous and metamorphic rocks. Aragonite is a polymorph of calcite. It is less widespread and abundant than calcite and is formed under a much narrower range of physio-chemical conditions. Aragonite is technically unstable at normal surface temperatures and pressures, converting naturally to calcite. As result, the calcium carbonate of natural limestones is mainly calcite. Dolomite is composed of calcium magnesium carbonate CaMg(CO₃)₂ found in crystals. The calcium and magnesium ions are separated in different layers. Dolomite has physical properties similar to those of calcite, but does not rapidly dissolve or effervesce in dilute hydrochloric acid unless it is scratched or in powdered form. Calcite is far more common and effervesces easily when acid is applied to it. Dolomite is also slightly harder, denser and never forms scalenohedrons, unlike calcite.

Calcium carbonate in the form of calcite is the primary mineral component in many natural rocks, primarily in limestone, but also in marble, and volcanic rocks such as carbonatites, kimberlites, or peridotites. It has been found that minerals with a higher content of calcite have improved effectiveness as a sorption media. A particularly useful source of calcium carbonate for purposes of the present invention is limestone. Limestone is a commonly-found sedimentary rock. It is readily available and relatively inexpensive, particularly in the quantities utilized in the present invention. Several different types of limestone exist and are differentiated based on the texture (e.g., oolitic limestone), mineral content (e.g., dolomitic limestone), origin (e.g., coral) and geological age (e.g., carboniferous limestone). Most limestone is partly or wholly organic in origin and contain the shells of marine organisms, such as mollusks and coral. Fossiliferous limestone varies in color, strength, and porosity. Some common ones include micrite, oomicrite, pelmicrite, biomicrite, fossiliferous micrite, biosparite, dismicrite, microspar, fossiliferous limestone, stromatolites, coquina, chalk, oolitic limestone, intraclastic limestone, pelleted or peloidal limestone, crystalline limestone, travertine, tufa, marble, coral limestone, and dolostone.

The carbonates of the present invention can comprise at least about 70%, or about 75%, or about 80%, or about 85%, or about 90%, or about 95% by weight of calcium carbonate particles. The carbonates can also comprise up to about 1%, or up to about 2%, or up to about 3%, or up to about 4%, or up to about 5%, or up to about 10%, or up to about 15%, or up to about 20%, or up to about 25%, or up to about 30% by weight of magnesium carbonate particles.

Limestones from different sources can have significant different physical characteristics. For example, coral limestone is clearly different and distinguishable from natural crystalline limestone because coral limestone has not undergone geologic processes and has not become lithified, as crystalline limestone has in its forms. The density of crystalline limestone is typically about 2.3 g/cm³ to about 2.7 g/cm³, whereas coral limestone typically can be orders of magnitude less dense, in the range of about 0.02 g/cm³ to 0.1 g/cm³. The porosity of crystalline limestone typically can be about 1% to less than about 20%, whereas the porosity of coral limestone can be 20% or greater. Limestones are common materials found in many parts of the world are often identified by their location. Some of the more common limestones in the United States include Bear Gulch, Coquina, Greenbrier, Indiana (including Harrodsburg), Kaibab, Kasota, Kentucky, Keystone, Madison, Miami, Minnekahta, Minnelusa, Ste. Genevieve, and St. Louis. Preferred sources of limestone include Minnekahta and Ste. Genevieve. Limestone can include Calcite Rock and Sea Aragonite.

Calcium carbonate minerals used in the present invention may be in a variety of physical forms, including the natural or raw material form (as extracted from the ground or from rock), powder, common sand, dust, chips, clumps, and larger chunks or rocks. The calcium carbonate can be processed to a specified size to obtain optimal surface area, or formed into pellets, blocks, or other shapes using processes as such as agglomeration. Calcium carbonate minerals may also be sintered for improved properties.

While not intending to be bound by any particular theory, it is believed the mechanism of action for the removal of chemical species by the sorption media is sorption. Sorption includes adsorption, absorption, precipitation/dissolution and co-precipitation. The processes that appear to affect the efficiency of the sorption media are primarily surface phenomena. It should be noted, however, that there is often no distinction made whether adsorption, absorption, precipitation/dissolution or coprecipitation is the sorption process involved. Various factors can affect sorption or removal efficiency of the sorption media. Such factors include, but are not limited to, surface microtopography, surface area, particle shape, particle size, and mineral content, particularly the form and content of calcium carbonate.

When considering carbonate surface chemistry, adsorption is of particular importance, either in the form of chemical or physical adsorption. Physical adsorption primarily involves weak Van der Waals forces and electrostatic interactions, and does not involve the sharing or transfer of electrons. Chemical adsorption involves electron transfer and the formation of a relatively strong chemical bond between the absorbate and absorbent.

In one embodiment of the present invention, the sorption media contains carbonate minerals or calcium carbonate minerals. The calcium carbonate mineral can be calcite, aragonite, dolomite, and mixtures thereof. Preferably, the calcium carbonate is calcite mineral. The calcite mineral can also include limestone. In the present invention, the amount and types of minerals in the sorption media, especially the calcite content, are determined by X-ray diffraction analysis. The calcite content of the sorption media can be no less than about 70%, or about 75%, or about 80%, or about 85%, or about 90%, or about 91%, or about 92%, or about 93%, or about 94%, or about 95%, or about 96%, or about 97%, or about 98%, or about 99% of the mineral.

In one aspect, the sorption media or carbonate minerals or the calcium carbonate minerals used in the present invention can have a range of particle sizes. Typically, the particle sizes can range from a diameter from approximately 0.001 mm to approximately 7 mm, from approximately 0.001 mm to approximately 2 mm, from approximately 0.001 mm to approximately 1 mm, from approximately 0.05 mm to approximately 5 mm, from approximately 0.05 mm to approximately 2 mm, from approximately 0.5 mm to approximately 1 mm, from approximately 0.1 mm to approximately 5 mm, from approximately 0.1 mm to approximately 2 mm, from approximately 0.1 mm to approximately 1 mm, from approximately 0.5 mm to approximately 2 mm, from approximately 0.5 mm to approximately 1 mm, from approximately 0.2 mm to approximately 0.5 mm, from approximately 1 mm to approximately 2 mm, and less than approximately 0.5 mm.

For a given volume, smaller particles have greater surface area as measured by BET (Brunauer, Emmett, and Teller) specific surface area, and therefore greater sites with which the heavy metal may be able to interact. The sorption media or carbonate minerals or the calcium carbonate minerals used in the present invention can have a BET specific area from about 0.1 m²/g to about 20 m²/g, or from about 0.2 m²/g to about 10 m²/g, or from about 0.3 m²/g to about 5 m²/g, or from about 0.5 m²/g to about 7 m²/g, or from about 0.7 m²/g to about 7 m²/g, or from about 0.7 m²/g to about 5 m²/g. Alternatively, sorption media or carbonate minerals or the calcium carbonate minerals may be formed into pellets (granules) with a diameter from approximately 0.001 mm to approximately 2 mm, or approximately 0.001 mm to approximately 1 mm, or from approximately 0.005 mm to approximately 1 mm in diameter. The formed pellets formed can have a BET specific area from about 0.1 m²/g to about 20 m²/g, preferably from about 1 m²/g to about 10 m²/g, more preferably about 2 m²/g to about 8 m²/g. The particle size will normally be selected for the effect to be achieved in the finished product, and mixtures of particle sizes can be used in combination.

Other properties of the sorption media or carbonate minerals or calcium carbonate minerals which may affect the efficiency and capacity of heavy metal removal are density and porosity. However, if the mechanism of action for removal of a particular heavy metal is through precipitation reaction of heavy metal species with calcium or magnesium carbonates on the surface of sorption media, these two factors should have very limited effects. Therefore, the present invention is not limited by the density or porosity of calcium carbonate minerals. In one aspect, the sorption media or carbonate minerals or the calcium carbonate minerals used in the present invention have a density of no less than about 0.2 g/cm³, or no less than about 0.5 g/cm³, or no less than about 1 g/cm³, or no less than about 1.5 g/cm³, or no less than about 2 g/cm³. In another aspect, it is preferable that sorption media or carbonate minerals or the calcium carbonate minerals have a porosity of no greater than about 70%, more preferably no greater than about 50%, yet more preferably no greater than about 30%, yet more preferably no greater than about 20%, yet more preferably no greater than about 15%, yet more preferably no greater than about 10%, and most preferably no greater than about 5%.

In another embodiment, the sorption media is agglomerated or granulated to form larger granules from the powdered form. Agglomeration or granulation, as used herein, is the production of a granular solid through size enlargement of the particles, typically by addition of a binder material. The terms agglomerate and granule refer to the solid produced through agglomeration and granulation. While a smaller particle size and increased surface area can lead to improved heavy metal sorption onto the sorption media, it also can reduce the effectiveness of the sorption media as filtering media. The finer particles reduce the flow-through capacity, leading to a constricted flow, which limits the practical effectiveness.

Agglomeration can be used to produce sorption media that allows the sorption media to effectively act as a filtering media, such as for use in a column. A larger agglomerated or granulated particle allows for water flow through a column. Producing agglomerates or granules from powdered sorption media allows the higher surface area of the powder to be exposed on the surface of the agglomerate or granule. This process is especially useful for these materials with grain sizes less than about 0.2 mm in diameter. The particles of such size are too small to be used practically in a flow-through system, simply because the flow rate is going to be too slow and back pressure will be too high. Hence, an advantage of agglomeration is that it significantly increases material surface area without compromising flow-through rates. Another advantage is that it allows addition of other chemical additives, such as magnesium carbonate, to enhance the heavy metal removal efficiency.

Agglomeration of fine powders can be accomplished through agglomeration technologies that are well-known in the art. This includes, but is not limited to, three common processes: a) tumble/growth agglomeration; b) pressure agglomeration; and c) agglomeration by heat or sintering. Binders are substances that are added either prior or during the agglomeration process to increase the strength of the agglomerated material. The binder for use with a particular sorption material depends on the type and nature of the sorption material and the intended uses and properties of the resulting agglomerated material. Binders can be organic or inorganic material, and can be soluble or insoluble. The proper binder should result in agglomerated particles that are firm enough to hold their shape, and do not dissolve or otherwise decompose when exposed to water or flow streams. Typically, the binder is a cement, such as hydraulic cement.

In another embodiment, the sorption media further comprises one or more binders, such as, but not limited to, cements, including hydraulic cement. The hydraulic cement used in the present invention includes, but is not limited to, Portland cement, modified Portland cement, or masonry cement, and mixtures thereof. By “Portland cement”, it is meant all cementitious compositions which have a high content of tricalcium silicate and includes Portland cement and cements that are chemically similar or analogous to Portland cement, the specification for which is set forth in ASTM specification C 150-00. Other types of binders suitable for uses in the present invention include alkaline silicates, silica hydrosol, alumina, silica-alumina, gypsum, plaster of paris, and clays, such as colloidal clays.

Water is sprayed into the mixture of ore particles and a binder such as Portland cement, and the mixture is then tumbled until granules form. The granules are sieved and dried in a curing room. When an appropriate amount of a water insoluble binder is used, the granules are firm enough to hold their shape in a column and do not disintegrate when exposed to water. The amounts of components in the sorption media can vary between about 50 wt % and about 95 wt % calcium carbonate minerals and between about 50 wt % and about 5 wt % of one or more binders. Preferably, the sorption media contains over about 70% by weight of calcium carbonate minerals, more preferably over about 85% by weight of calcium carbonate minerals, and most preferably over about 90% by weight of calcium carbonate minerals.

The heavy metal removal efficiency of sorption media used in the present invention can be further enhanced through chemical modifications and formulations. The increased efficiency can significantly decrease the amount of waste materials, the amount of handling by personnel, the size and quantity of equipment for a given system, and thus the overall cost of removing heavy metal down to lower levels.

In another embodiment, the surface of the sorption media is modified chemically to improve the heavy metal removal efficiency. A variety of inorganic and organic chemicals can be used for this purpose, including ferric chloride, ferric hydroxide, aluminum sulfate, and magnesium hydroxide. Water-soluble magnesium salts of organic and inorganic acids can also be used. Examples of suitable inorganic magnesium salts include, without limitation, magnesium halides, such as chloride, bromide, and iodide, and magnesium nitrate. Examples of suitable organic magnesium salts include, without limitation, carboxylates, such as formate, acetate, propionate, and butyrate; dicarboxylates, such as oxalates, malonates, succinates, glutarates, adipates, maleates, and fumarates; and hydroxycarboxylates, such as lactate and gluconate. A combination or mixture of any of the foregoing chemicals can also be used.

Preferably, calcium carbonate particles are chemically modified with magnesium salts, and more preferably magnesium organic salts, to improve heavy metal removal efficiency. One typical method of chemical modification involves exposing calcium carbonate particles with desired sizes to a concentrated magnesium salt solution so that calcium cations on the surface of calcium carbonate particles can exchange with magnesium cations in solution to form magnesium carbonate aggregates nearly exclusively on the surface of the particles. Essentially, the calcium carbonate particles are coated with magnesium carbonate. The magnesium carbonate thus formed is accessible and readily reacts with heavy metal compounds in heavy metal-contaminated water. The Ca²⁺/Mg²⁺ exchange on the particle surface can be accelerated by physical agitation such as stirring. Additionally, factors such as reaction temperature and duration, magnesium salt concentration, the amount of calcium carbonate minerals and particle sizes can also affect the extent of the exchanges. The amount of magnesium on the particle surface can be estimated by elemental analysis and can be expressed as percentage of magnesium ion over the total of calcium and magnesium ions, such as greater than 1%, greater than 5%, greater than 10%.

In a further embodiment, the heavy metal removal efficiency and capacity of the sorption media is increased by mixing with other additives, such as magnesium carbonate. Magnesium carbonate is widely available commercially as a solid powder and preferably, is physically mixed with calcium carbonate minerals. The amount of magnesium carbonate in this composition is no greater than about 10% by weight, or about 9% by weight, or about 8% by weight, or about 7% by weight, or about 6% by weight, or about 5% by weight, or about 4% by weight, or about 3% by weight, or about 2% by weight, or about 1% by weight. For example, the sorption media having magnesium carbonate about 10% by weight, the heavy metal removal efficiency can be doubled. The mixture of calcium carbonate minerals, additives, and binders can be further processed into granules or pellets as described hereinabove. The amounts of carbonate minerals to one or more additives and binders in the sorption media can be about 90:10% by weight, or about 80:20% by weight, or about 70:30% by weight, or about 60:40% by weight, or about 50:50% by weight, or about 40:60% by weight, or about 30:70% by weight, or about 20:80% by weight, or about 10:90% by weight.

Other additives may be employed to increase the adsorption of heavy metal from solution. For example, activated aluminum may work, but creates reaction products that are difficult and expensive to handle. Iron oxide may work, but also creates processing problems, including rust formation, iron precipitates, and iron staining of water.

When the sorption media is used to remove heavy metal from water, the level of heavy metal in the water can be reduced, preferably to below approximately 30 parts per billion (ppb), or to below approximately 25 ppb, or to below approximately 20 ppb, or to below approximately 15 ppb, or to below approximately 10 ppb, or to below approximately 5 ppb.

### Process and Apparatus:

The heavy metal-contaminated solution may be from any source of an aqueous solution, such as, but not limited to, water, including surface and underground sources, and may be used for water directed to any water system or user, including large water treatment systems, rural or smaller water systems, or individual users. The relative simplicity of the present invention substantially reduces the cost and technical requirements of conventional heavy metal remediation techniques, which makes it particularly useful for individual users, rural communities, or relatively smaller water systems. The present invention may be employed at the point of the source of the water, at the point of use by the end user, or at any point between the source and the user. The water may contain heavy metal in levels considered to be unhealthy for human consumption or use, e.g., up to about 100 ppb heavy metal and higher.

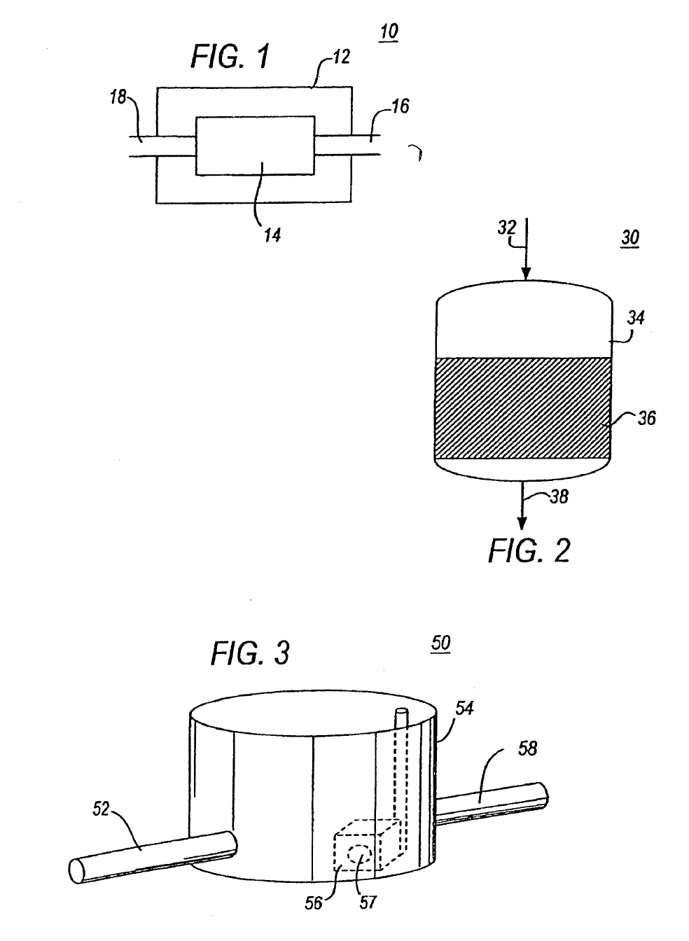

Contacting heavy metal-contaminated water with the sorption media of the present invention may be accomplished in a variety of ways. For example, heavy metal-contaminated water may be passed in a substantially continuous flow through a filter containing the sorption media. As shown in FIG. 1, the heavy metal contaminated water may be introduced into filter system 10 through inlet 16, passed in a substantially continuous flow through cartridge 14 containing the sorption media, and removed from the filter system 10 through outlet 18. The filter system 10 preferably comprises a housing 12 to hold the cartridge 9 containing the sorption media, particularly in a point-of-use application utilizing a filter system. When the sorption media is in need of replacement, the cartridge 14 may be supplied with additional or replacement sorption media or preferably the cartridge 14 may be removed and replaced with another cartridge containing fresh sorption media. A filter system 10 for a point of use application preferably would be sufficient compact to be installed within the house or building, more preferably under the sink or otherwise near the faucet. For such applications, the housing 12 and cartridge 19 preferably would be approximately 2 feet to approximately 3 feet in length and approximately 3 inches to approximately 6 inches in diameter and be configured to contain approximately 10 to approximately 15 pounds of sorption media.

In a filter system application, the preferred size, shape, and other characteristics of the sorption media generally depend on the desired flow rate of water, the level of heavy metal contamination, the sorption media used, and other factors. In general, as the size of the sorption media particles become smaller, the flow rates of the water through the filter decrease, eventually allowing insufficient or even no water to flow through the filter. On the other hand, as the size of the sorption media particles become larger, the number of potential reaction sites decreases and the efficiency of the system decreases. In a filter system application for an individual user, the limestone or dolomite is preferably crushed or ground, and in diameter, is: from approximately 0.001 mm to approximately 7 mm, from approximately 0.001 mm to approximately 2 mm, from approximately 0.001 mm to approximately 1 mm, from approximately 0.05 mm to approximately 5 mm, from approximately 0.05 mm to approximately 2 mm, from approximately 0.5 mm to approximately 1 mm, from approximately 0.1 mm to approximately 5 mm, from approximately 0.1 mm to approximately 2 mm, from approximately 0.1 mm to approximately 1 mm, from approximately 0.5 mm to approximately 2 mm, from approximately 0.5 mm to approximately 1 mm, from approximately 0.2 mm to approximately 0.5 mm, from approximately 1 mm to approximately 2 mm in diameter. Alternatively, the limestone or dolomite may be formed into pellets (granules), preferably approximately 0.001 mm to approximately 7 mm, from approximately 0.001 mm to approximately 2 mm, from approximately 0.001 mm to approximately 1 mm, from approximately 0.05 mm to approximately 5 mm, from approximately 0.05 mm to approximately 2 mm, from approximately 0.5 mm to approximately 1 mm, from approximately 0.1 mm to approximately 5 mm, from approximately 0.1 mm to approximately 2 mm, from approximately 0.1 mm to approximately 1 mm, from approximately 0.5 mm to approximately 2 mm, from approximately 0.5 mm to approximately 1 mm, from approximately 0.2 mm to approximately 0.5 mm, from approximately 1 mm to approximately 2 mm, and less than approximately 0.5 mm. As the volume of water to be treated increases, the amount of sorption media to be used also increases, with the sorption media preferably ground as fine as practicable.

In another embodiment of the present invention, the heavy metal-contaminated water may be passed through a packed column containing the sorption media. As shown in FIG. 2, heavy metal-contaminated water is introduced through inlet 32 into packed column 34 containing the sorption media 36. The water passes through the packed column of sorption media 36, which reduces the amounts of heavy metal in the water, and exits the packed column 34 through outlet 38.

The preferred size and characteristics of the column depend upon the end-use application. For a single household, the column may be small enough to fit under the sink or large enough to treat all of the household water. Generally, the size of any particular unit is a function of the desired water effluent flow rate, the acceptable pressure drop, and the desired length of time for the sorption media in the column to be in service. A column system has an advantage over a reservoir system in that the effluent water is treated and usable up until the time of heavy metal breakthrough, which occurs when the heavy metal concentration in the effluent water reaches an undesirable level. At that point, the packed column sorption media is nearly saturated with heavy metal compounds. The column may then be removed and replaced with another column containing fresh sorption media. Preferably, the sorption media is packed into the column so as to minimize water bypassing the sorption media and to minimize escape of the sorption media into the effluent water. For example, the sorption media may be packed in a gradient of sizes or with different particle sizes, e.g., with the smallest particles in the middle of the column and the largest sizes toward the outside. Inert materials, such as sand, or active materials, such as activated carbon, may also be used in the column ends to retain the fine sorption media particles. Screens or filters may be used to retain the sorption media particles.

In an application utilizing a packed column, the preferred size, shape, and other characteristics of the sorption media will depend on the desired flow rate of water, the allowable pressure drop, the desired velocity of water through the column, the level of heavy metal contamination, the sorption media used, and other factors. Again, as the size of the sorption media particles become smaller, the flow rates of the water through the filter decrease, eventually allowing insufficient or even no water to flow through the filter. On the other hand, as the size of the sorption media particles becomes larger, the number of potential reaction sites decreases and the efficiency of the system decreases. In a packed column application, the sorption media is preferably crushed or ground and classified, in diameter, from: approximately 0.001 mm to approximately 7 mm, from approximately 0.001 mm to approximately 2 mm, from approximately 0.001 mm to approximately 1 mm, from approximately 0.05 mm to approximately 5 mm, from approximately 0.05 mm to approximately 2 mm, from approximately 0.5 mm to approximately 1 mm, from approximately 0.1 mm to approximately 5 mm, from approximately 0.1 mm to approximately 2 mm, from approximately 0.1 mm to approximately 1 mm, from approximately 0.5 mm to approximately 2 mm, from approximately 0.5 mm to approximately 1 mm, from approximately 0.2 mm to approximately 0.5 mm, from approximately 1 mm to approximately 2 mm, and less than approximately 0.5 mm. Alternatively, the sorption media may be formed into pellets, preferably approximately 1 mm to approximately 2 mm in diameter/length, and most preferably approximately 0.005 to approximately 1 mm in diameter/length. As the volume of water to be treated increases, the amount of sorption media to be used increases and the sorption media preferably is crushed to a relatively smaller particle size.

In yet another embodiment of the invention, heavy metal-contaminated water may be treated within a reservoir, including a reservoir used as storage. As shown in FIG. 3, in a reservoir treatment system 50, heavy metal-contaminated or contained water is introduced through inlet 52 into reservoir 54. Sorption media 57 is placed into reservoir 54 such that the heavy metal-contaminated water comes in contact with at least a portion of the sorption media 57 before exiting through outlet 58. The reservoir 54 may be anything that is capable of holding a volume of water, such as a well, a tank, or a tower. Water in relatively small reservoirs, such as individual water bottles or containers, may also be treated by placing the sorption media into an enclosure, such as a tea bag, that is adapted to allow direct contact between the sorption media and the water when the enclosure is inserted into the reservoir. The sorption media 57 may be placed in contact with the heavy metal-contaminated water in any number of ways, including placing and mixing the sorption media 57 directly into the water, inserting into the heavy metal-contaminated water a container, such as a bag with a porous membrane or a cage-like box that allows direct contact between the heavy metal contaminated water and the sorption media 57 held within the container, or by positioning the sorption media 57 in proximity to the outlet of the reservoir. Alternative methods may include incorporating the sorption media through materials processing techniques into a rigid yet porous base or by incorporating the sorption media as a surface coating on a rigid, porous medium.

In an application where the sorption media is inserted into a reservoir, the preferred form of sorption media depends in part on the apparatus employed to house the sorption media. For example, a bag or other container comprising a porous membrane may contain sorption media that is finely ground, crushed, coarsely broken into pieces, blocks, natural or simply in the form that is most readily available. The openings in the membrane are designed to be sufficiently large to allow water to pass through the membrane but sufficiently small to contain the sorption media. In this application, it is preferred to employ an sorption media that is relatively finely ground, such as approximately 0.001 mm to approximately 1 mm in diameter, to provide a relatively large number of potential reaction sites for the heavy metal. For example, a membrane composed of plastic or similar materials may be used to contain sorption media ground that are approximately 0.001 mm to approximately 1 mm in diameter. Larger openings in the membrane or in the sides of the container preferably would result in using correspondingly larger-size particles of sorption media. In a simple form, a single block of sorption media may be placed on a platform or in an open cage. Most preferred is sorption media finely ground to submicron particle size and molded to form porous pellets approximately 1 mm to approximately 2 mm in diameter, or approximately 0.1 to approximately to 0.5 mm in diameter, or approximately 0.5 mm to approximately 1 mm in diameter.

As an example, one may consider the case of a relatively small water treatment plant for approximately 250 to approximately 300 homes that utilizes water from a well and stores it in a water tower. In such a system, one may employ the present invention in a variety of ways, including by distributing filter systems or packed column systems to each end user, installing a packed column at the effluent of the water tower, inserting the sorption media into the water tower, as set forth above, or installing a packed column to treat the water before it is stored in the water tower. In this case of a relatively small water treatment plant, it is generally preferred to either distribute filter sorption media systems to each end user or to install a packed column to treat the water before it is stored in the water tower, alternatively, by providing each end user with a packed column sorption media system, the end user may preferentially treat only the water that needs to be treated. This will lower the expense to the end user, who may selectively treat only water to be used for human consumption and not treat water for other uses, such as for plants, the lawn, in toilets, etc.

Over time, the sorption media will be consumed by its reaction with the heavy metal in the water and will need to be replaced with fresh sorption media. The length of time between such replacement of sorption media will depend on a number of factors, including the volume of water treated, the amount of heavy metal and other contaminants in the water, and the amount, size, shape, and type of sorption media used, among other things. To determine the appropriate time to replace the sorption media, the operator may regularly follow a proscribed schedule based on these factors, as provided by the supplier, or preferably test the water and/or the sorption media to determine whether replacement of the sorption media is necessary or desired.

Employing the present invention to treat even relatively large volumes of water with heavy metal in amounts above drinking-water standards produces a relatively small and compact amount of solid sorption media with adsorbed heavy metal. Because the heavy metal is believed to be strongly bound to the sorption media, heavy metal is not expected to significantly leach out under normal waste disposal conditions. For example, using limestone as the sorption media in the present invention generates an heavy metal-laden waste limestone, which is relatively stable, even when subjected to the low pH (e.g., pH=2.88) environment of a Toxicity Characteristic Leaching Procedure Test.

### EXAMPLES

The efficiency of a sorption media of the present invention can be generally evaluated using either batch or column experiments. Batch experiments were conducted using Minnekahta or Kentucky Limestone as the primary limestone source. Other limestone units and additives to improve efficiency can also be tested as appropriate. The limestone was crushed using a roller crusher and then sieved to various size ranges. Samples of the limestone adsorbent were placed in labeled round-bottomed flasks. Samples were mixed with 100 mL of varying heavy metal solution concentrations (depending on the experiment). Heavy metal solutions were pH-balanced to a pH of 8 prior to mixing with the material sample. In addition, batch tests included a blank sample of 100 mL deionized water rather than heavy metal solution. Sample flasks were secured to a wrist shaker and agitated for 48 hours unless otherwise stated in the experiment description. After mixing, the samples were filtered with a 0.45 μm filter. The samples were then analyzed for heavy metal concentration. The pH and conductivity of the samples can also be measured.

Column experiments can be conducted using Minnekahta Limestone. Material with a particle size range of 0.2-0.5 mm can be used primarily, although columns with other limestone size ranges and with manufactured limestone granules can be run. The columns can be constructed of PVC pipe of varying diameters and lengths, depending on the column design. Influent heavy metal solution can be mixed to varying concentrations, depending on the experiment, and pH balanced to a pH of 8. Influent can be pumped into the column from the bottom up at a constant flow rate. Samples of effluent can be collected regularly. The pH and conductivity of the effluent can be measured and the samples can be analyzed for heavy metal concentration.

### Example I

### BET Surface Area Measurement

Specific surface area was analyzed using the Micromeritics Gemini III 2375 specific surface area analyzer. Batch experiments have shown that the smaller the limestone particle size, the greater the percent heavy metal removal per gram of limestone. As particle size decreases, the effective surface area per gram of the stationary phase increases. BET (Brunauer, Emmett, and Teller) specific surface area analysis was completed to determine the total surface area of the different materials. Table 2 is a summary of the BET specific surface area results for materials used in batch and which can be used column experiments.

BET results show that ball-milled limestone varies in surface area from about 0.8 m²/g to about 4.6 m²/g. Manufactured limestone granules composed of varying amounts of ball-milled Minnekahta Limestone, Portland cement binder, and magnesium carbonate have surface areas greater than ball-milled limestone. Granule surface areas ranged from about 4.4 m²/g to about 6.4 m²/g. BET results of granular ferric hydroxide (GFH) indicate that the surface area of GFH is about 140 times greater than that of ball-milled Minnekahta Limestone.

TABLE 2
BET Surface Area Measurements

| | BET Surface |
|---|---|
| Sample Description | Area (m²/g) |
| Ball-milled Minnekahta Limestone(<0.001 mm) | 0.7922 |
| Ball-milled Minnekahta Limestone(<0.001 mm) | 0.8815 |
| Ball-milled Minnekahta Limestone(<0.001 mm) | 4.6806 |
| Manufactured granules composed of 10% Portland | 5.3051 |
| cement and 90% Minnekahta Limestone | |
| Manufactured granules composed of 15% Portland | 6.3898 |
| cement and 85% Minnekahta Limestone | |
| Manufactured granules composed of 10% Portland | 4.3692 |
| cement, 87% Minnekahta Limestone, and 3% reagent | |
| grade MgCO₃ | |
| Portland cement binder used in granulation | 2.1813 |
| Plaster of Paris binder used in granulation | 3.8623 |
| Illite clay (<4 μm, or 4 micrometers) | 9.7051 |
| MgCO₃—Reagent Grade | 22.2600 |
| Granular Ferric Hydroxide | 128.6405 |

### Example II

### Particle Size Analysis

Particle size analysis on different types of limestone materials, reagent grade chemicals used as additives, and clay materials, was performed using the Microtrac Model S3000 Particle Size Analyzer. This instrument uses the phenomenon of scattered light from laser beams projected through a stream of suspended particles to measure particle size. The amount and direction of light scattered by the suspended particles were measured by an optical detector array and analyzed using Microtrac software. Results are reports as average particle size in microns.

TABLE 2
Particle size measurements

| | Average Particle |
|---|---|
| Material Type | Size (microns) |
| Minnekahta Limestone (<0.5 mm sieve size) | 15.82 |
| Minnekahta Limestone (ball-milled on Apr. 14, 2003) | 6.66 |
| Minnekahta Limestone (ball-milled on Apr. 12, 2004) | 6.55 |
| Madison Limestone (<0.5 mm sieve size) | 15.23 |
| Madison Limestone (ball-milled) | 7.60 |
| Madison Dolomite (<0.5 mm sieve size) | 16.44 |
| Madison Dolomite (ball-milled) | 7.93 |
| Minnelusa Formation (<0.5 mm sieve size) | 13.95 |
| Minnelusa Formation (ball-milled) | 9.08 |
| Kentucky Limestone (ball-milled) | 3.34 |
| Calcite Rock - Turkey (ball-milled) | 53.42 |
| Aragonite (CaribSea brand) (ball-milled) | 56.02 |
| CaCO₃ (reagent grade) (Fisher brand) | 10.81 |
| CaCO₃ (reagent grade) (Aldrich brand) | 64.66 |
| MgCO₃ (reagent grade) | 16.34 |
| Illite (<4 micrometers) | 4.73 |
| Montmorillonite (<4 micrometers) | 4.28 |
| Kaolinite (<4 micrometers) | 7.40 |

These results provide an average particle size for the limestone materials, additives used to improve heavy metal removal efficiency, and clay materials used in batch experiments. Ball-milling of limestone material generally reduced the average particle size to the level of microns (0.001 mm), far less than half of that seen in the limestone that was sieved to less than 0.5 mm. The calcite rock from Turkey was not ball-milled long enough to produce consistently smaller particles.

### Example III

### Characterization of Crystal Contents using X-Ray Diffraction (XRD) Analysis

Table 3 shows XRD analysis results for five different limestone or dolomite formations. These rock units are all from the Black Hills of South Dakota, except one limestone unit from Kentucky (Ste. Genevieve Limestone).

TABLE 3
XRD analysis results for five limestone and dolomite rock formations.

| Limestone Type and Source | XRD Analysis Results | |
|---|---|---|
| Sainte Genevieve | Calcite—95.5% +/− 2.3 | Quartz—0.2% +/− 0.1 |
| Limestone - Kentucky | Dolomite—4.3% +/− 0.7 | |
| Minnekahta Limestone - | Calcite—92.7% +/− 2.1 | Microcline—1.2% +/− 0.8 |
| Rapid City, SD | Quartz—2.9% +/− 1.3 | Albite—0.2% +/− 0.2 |
| Madison Formation | Dolomite—97.8% +/− 3.4 | Quartz—0.2% +/− 0.2 |
| Limestone - Rapid City, SD | Calcite—2.0% +/− 0.8 | |
| Madison Formation | Dolomite—98.5% +/− 2.7 | Quartz—0.4% +/− 0.2 |
| Dolomite - Rapid City, SD | Calcite—1.1% +/− 0.6 | |
| Minnelusa Formation - Rapid | Dolomite—84.3% +/− 4.3 | Pyrrhotite—2.0% +/− 2.0 |
| City, SD | Quartz—6.6% +/− 1.1 | Illite—1.6% +/− 1.0 |
| | Calcite—3.9% +/− 1.0 | Microcline—0.8% +/− 0.4 |
| | | Kaolinite—0.7% +/− 0.4 |

### Example IV

### First Batch Study: Removal of Heavy Metals with Limestone

Batch experiments were conducted with aqueous solutions of lead, zinc, chromium, manganese, cadmium, or selenium. Four flasks were prepared for each metal by adding 100 parts per billion (ppb) of the metal to 100 mL water. Ball milled Minnekahta Limestone in the amounts of 0.5 g, 1.0 g, 2.5 g, and 5 g was added to the separate flasks for each metal. The flasks were agitated for 48 hours and the final heavy metal concentration was measured. Two separate batch tests were run for each of lead, zinc and chromium. One batch test was run for manganese, cadmium, and selenium.

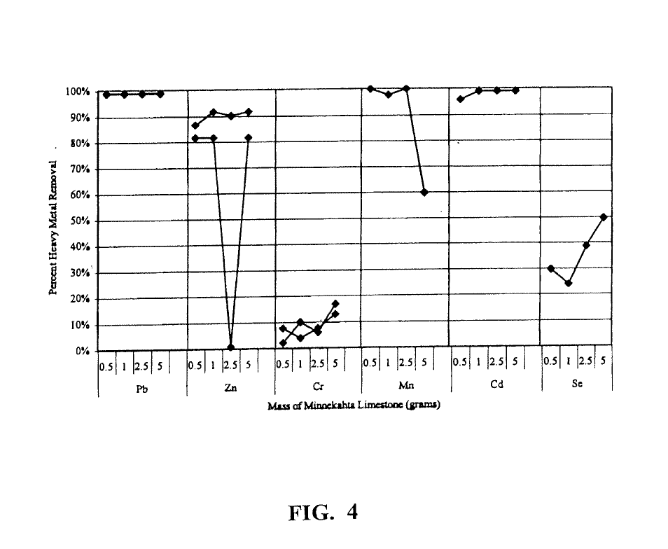

The results are shown in FIG. 4, which indicates a marked reduction in heavy metal concentrations with relatively small amounts of limestone (0.5 to 5 grams). Lead and cadmium were removed most efficiently, with nearly 100% removal of both even with small amounts of limestone. Limestone also removed zinc from the solution. Two batch tests were conducted to normalize the data, one with a zinc concentration of 100 ppb, the other with a 400 ppb concentration. The normalized data show agreement on the percentage of zinc removal with the exception of one data point.

The two other metals, chromium and selenium, were removed from the solution. Selenium removal showed a linear trend as the amount of limestone increased, reaching a 50% removal rate. Chromium removal averaged approximately 18% removal.

### Example V

### Second Batch Study: Removal of Mercury with Limestone

A batch experiment was conducted with aqueous solutions of mercury. Ten flasks were prepared with 100 mL water and 100 ppb mercury. Kentucky limestone with a sieve size less than 0.5 mm in the amounts of 2.50 g, 5.00 g, 7.50 g, 10.00 g, and 12.50 g was added to the separate flasks. Kentucky limestone with a sieve size of 1-2 mm in the amounts of 2.50 g, 5.00 g, 7.50 g, 10.00 g, and 12.50 g was added to the remaining flasks. The flasks were agitated for 48 hours and the final heavy metal concentration was measured.

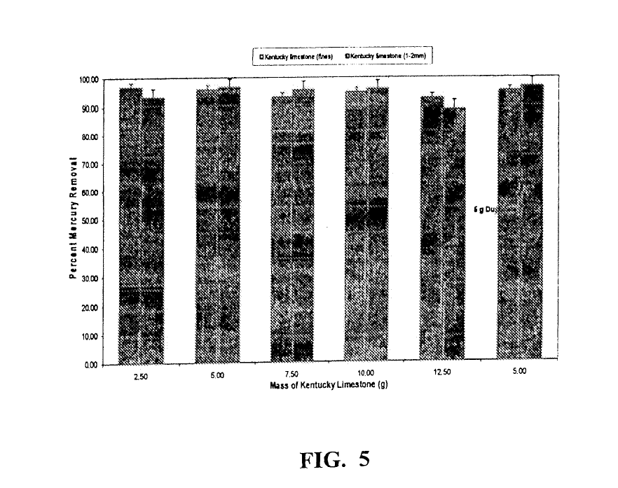

The results are shown in FIG. 5, which indicates a greater than 95% removal of mercury from the solution regardless the amount of limestone.

### Example VI

### Third Batch Study: Removal of Heavy Metals in the Presence of Arsenic with Limestone

Batch experiments were conducted with aqueous solutions of lead, zinc, chromium, manganese, cadmium, or selenium. Four flasks were prepared for each metal by adding 100 parts per billion (ppb) of the metal to 100 mL water and 100 ppb arsenic, with the exception of zinc, where 400 ppb was added. Ball milled Minnekahta Limestone in the amounts of 0.5 g, 1.0 g, 2.5 g, and 5 g was added to the separate flasks for each metal. The flasks were agitated for 48 hours and the final heavy metal concentration was measured.

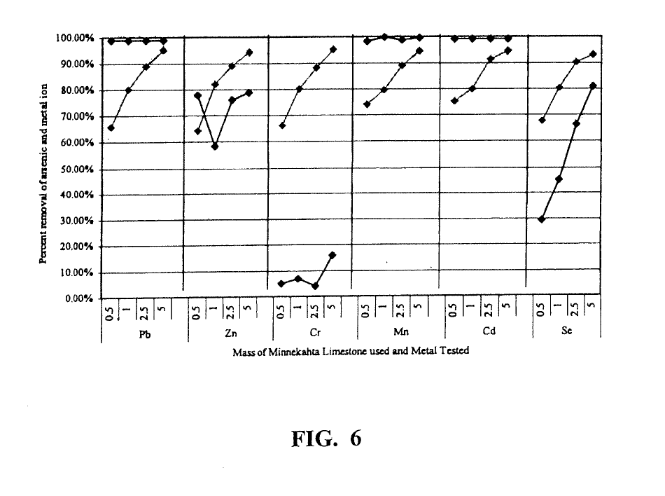

The results are shown in FIG. 6, which indicates a marked reduction in heavy metal concentrations with relatively small amounts of limestone (0.5 to 5 grams). The removal of lead, cadmium, chromium and manganese was not affected by the presence of arsenic. The percentage of removal of the heavy metals is similar to that seen in Example IV. The removal rate of zinc in the presence of arsenic is approximately 15% lower than zinc alone. The removal rate of selenium in the arsenic-infused solutions increased from 10-30% compared to selenium alone. The removal efficiency of selenium alone was 50% compared to 80% in combination with arsenic.

### Example VII

### Batch Study of Heavy Metal Removal with Limestone: pH Effect

Batch testing can be done to study the effect of pH on the removal of heavy metals by limestone. Various types and sizes of limestone can be agitated with 100 mL water containing 100 ppb heavy metal for 48 hours at varying initial pH values. The concentration of heavy metals in the resultant solutions can show the heavy metal concentration throughout the pH range tested.

### Example VIII

### Batch Study of Heavy Metal Removal with Treated Limestone

Native limestone and reagent-grade CaCO₃ particles can be modified using concentrated magnesium acetate solution in order to study the heavy metal removal efficiency of the limestone material. The modification of limestone involves exposing the limestone to a concentrated magnesium acetate solution so that calcium ions (Ca²⁺) from naturally occurring limestone or CaCO₃ will surface exchange with magnesium ions (Mg²⁺) from the concentrated solution on an atomic scale. The surface exchange reaction occurring during the modification of limestone with magnesium acetate is shown below. Surface exchange experiments can be conducted by adding a known concentration of magnesium acetate solution to a known amount of limestone. The solution can then be magnetically stirred. The surface exchange reaction may occur as shown in the following reaction.

CaCO₃(s)+Mg²⁺(aq) [symbol] MgCO₃(s)+Ca²⁺(aq)

Surface exchange experiments can be done by adding 500 mL 1.33 moles/L of magnesium acetate solution to either 25 g of calcium carbonate or 25 g of Minnekahta Limestone (ball-milled fines and 1-2 mm sieve size) or Kentucky Limestone (Ste. Genevieve Limestone) (1-2 mm) and magnetically stirring the solution for 24 hours. The equilibrium constant (K_{eg}), Gibbs free energy change of reaction ΔGᵣₓₙ°), and ΔG can be calculated for the surface exchange reaction. The efficiency of the heavy metal removal using magnesium-acetate-treated CaCO₃ or magnesium acetate treated limestone of ball-milled fines can be compared to the same of untreated limestone

Additional surface exchange experiments can be done by adjusting the {Mg²⁺}/{Ca²⁺} ratio, and increasing the temperature and the reaction time in order to bring the process closer to equilibrium. Experiments can be conducted by adding 15 g of limestone to 250 mL 2.5 moles/L of magnesium acetate solution and shaking it with a wrist shaker at 66° C. for 1 week. The concentrations of calcium and magnesium in CaCO₃ and various limestones at various sizes can be determined before and after surface exchange. The surface exchange experiment can be conducted at 66° C. for 1 week to determine in the magnesium content in the calcium carbonate and limestones.

Batch tests can then performed to compare the adsorptive capacity of the treated limestone with the adsorptive capacity of untreated limestone. The percent amount of removal of heavy metals can be calculated for the magnesium-acetate-treated limestones and the untreated limestones.

### Example IX

### Granulation of Limestone Using an Agglomeration Process

In order to maintain high surface area without compromising the flow-through rate, powdered limestones with a grain sizes less than 0.2 mm in diameter can be processed through agglomeration into spherical granules. To enhance the mechanical strength of their granules, a water-insoluble binder, Portland cement, can also be added to yield a mixture with 10% binder. During agglomeration, water can be sprayed into the mixture of limestone and binder and the mixture can be tumbled until granules formed. The granules can then be sieved and dried in a curing room. The granules should be firm enough to hold their shape in a column and should not disintegrate when exposed to water.

Additives can also be added to the dry mixture in order to enhance heavy metal removal efficiency. Granules of limestone with Portland cement binder and two different additives, magnesium carbonate and calcium carbonate, can also be prepared.

### Example X

### Batch Study of Heavy metal Removal with Granular Limestone

Batch tests can be performed to compare heavy metal removal by granules with 5 percent, 10 percent, and 15 percent binder. Batch tests can also be done with one percent and three percent of each additive added to see how this may improve heavy metal removal efficiency. Each batch test with the granules can use 1.5 grams of granules as the adsorbent and 100 mL of 100 ppb heavy metal solution. The granules used can be 2 to 4 mm in size and can be made using ball-milled Minnekahta Limestone (typically<0.001 mm size). Batch tests can also be done with 1.5 grams of ball-milled limestone (not granulated) and 90 percent limestone/10 percent binder (not granulated) as a performance comparison for the granules.

### Example XI

### Column Study of Heavy Metal Removal with Granular Limestone

Column studies can be conducted to compare the efficiency of manufactured limestone-based granules to crushed limestone. One column can be run with 1-2 mm size manufactured limestone-based granules (containing Minnekahta Limestone, Portland cement binder, and reagent-grade magnesium carbonate) and the other column can be run with 1-2 mm sieve size limestone as a comparison. Both columns used 100 ppb heavy metal solution. Column size was 12 inches long by 1 inch diameter. A plot of the measured effluent heavy metal concentration during the total run time of 720 minutes (12 hours) can be prepared. Based on this graph, the time of breakthrough at 10 ppb can be determined. Flow through the column and the number of bed volumes per hour can be calculated. The amount of water passing through the column before complete exhaustion of the column material can be determined. This can be expressed in liters and as the number of bed columns.

### Example XII

### Characterization of the Long Term Stability of the Waste Product: Encapsulation of Heavy Metal-Treated Limestone in Concrete Mortar

The Toxicity Characteristic Leaching Procedure (TCLP) test can be performed in accordance with requirements in Environmental Protection Agency (EPA) Method SW 1311. The TCLP test can show the final leachate concentration of heavy metals, which can be compared with the current TCLP leachate concentration limit set for heavy metal-containing waste disposal in a landfill (5 mg/L). Thus, the TCLP test can be useful in determining the stability of the limestone waste product, and can show whether the heavy metal treated limestone waste product is nonhazardous and suitable for disposal in municipal landfills. The TCLP results can also be used to determine whether the heavy metal treated limestone can also be used as an aggregate in making concrete. The TCLP results and thermal analyses results can show whether the heavy metal-limestone waste product is thermally stable and can be used as a raw material in cement kilns for manufacturing cement. Thermal analysis of heavy metal desorption from the waste product can be analyzed on a TA 2960 SDT. The samples can be heated from room temperature to 1550° C. at a heating rate of 20° C./min under a flowing atmosphere (100 mL/min) in air. The TCLP test results can show whether any heavy metals desorbed from heavy metal-limestone waste after the thermal analysis.

### Example XIII

### Characterization of the Long Term Stability of the Waste Product: Thermal Stability

The potential for using the solid heavy metal-limestone waste product as a raw material in cement kilns can be evaluated. All the samples can be analyzed on a TA 2960 SDT. The samples can be heated from room temperature to 1550° C. at a heating rate of 20° C./min under a flowing atmosphere (100 mL/min). Thermogravimetric analysis (TGA) of heavy metal-limestone waste samples in air can show the temperatures at which substantial weight loss and/or thermal decomposition can occur. Acid digestion of the sample before and after thermal analysis can be done to show whether any heavy metals desorbed from the heavy metal-limestone waste. The results can be used to determine whether the limestone waste product is thermally stable and can be used as a raw material in cement kilns for manufacturing cement.

### Example XIIII

### Study of Heavy Metal Removal In Untreated Mine Drainage Water

Samples from the Gilt Edge site in the Black Hills of South Dakota were collected at the point where untreated mine drainage water enters the treatment plant. In the untreated samples, the cadmium concentration was 0.146 mg/L. The lead concentration was 0.049 mg/L. Iron was 48.2 mg/L, manganese was 8.32 mg/L, and sulfate was 1530 mg/L. Total arsenic was 0.006 mg/L. Table 4 shows concentrations of ions before treatment of the water.

TABLE 4
Concentrations of contaminants in mine
drainage water before treatment.

| Heavy Metals | Concentration (mg/L) | |
|---|---|---|
| Arsenic (As) | 0.006 | mg/L |
| Cadmium (Cd) | 0.146 | mg/L |
| Iron (Fe) | 48.2 | mg/L |
| Lead (Pb) | 0.049 | mg/L |
| Manganese (Mn) | 8.32 | mg/L |
| Sulfate (SO₄²⁻) | 1530 | mg/L |

For the removal of arsenic and heavy metals, crushed Minnekahta Limestone (0.5 to 1 mm size) was placed in 1-L Nalgene bottles during batch testing with untreated water from the field sites. The mass of limestone was 1000 g, and the volume of water was 640 mL. The bottles were agitated gently once each day for seven days. At the end of this period the water was filtered and samples were sent to MidContinent Laboratories of Rapid City, S. Dak., for analysis.

Cadmium concentrations in the Gilt Edge mine water samples, after treatment with limestone were less than the minimum detection limit of 0.001 mg/L. The method removed at least 99.3% of cadmium from the mine water. Lead concentrations, after treatment, also were <0.001 mg/L. The method removed at least 98% of the mass of lead from the mine water. Iron concentrations were <0.05 mg/L. Manganese concentrations were about 0.3 mg/L. Total arsenic concentrations were unchanged, at 0.006 mg/L. Results of analyses from the Gilt Edge site, after treatment with limestone, are shown in Table 5.

TABLE 5
Concentrations of contaminants in water, after treatment.

| Heavy Metals | Concentration (mg/L) | |
|---|---|---|
| Arsenic (As) | 0.006 | mg/L |
| Cadmium (Cd) | <0.001 | mg/L |
| Iron (Fe) | <0.05 | mg/L |
| Lead (Pb) | <0.001 | mg/L |
| Manganese (Mn) | 0.342 | mg/L |
| Sulfate (SO₄²⁻) | 1540 | mg/L |

The examples set forth above are provided to give those of ordinary skill in the art with a complete disclosure and description of how to make and use the preferred embodiments of the compositions and how to use the preferred embodiments of the methods, and are not intended to limit the scope of what the inventors regard as their invention. Modifications of the above-described modes (for carrying out the invention) that are obvious to persons of skill in the art are intended to be within the scope of the following claims. All publications, patents, and patent applications cited in this specification are incorporated herein by reference in their entireties and as if each such publication, patent, or patent application were specifically and individually indicated to be incorporated herein by reference.

What is claimed is:

1. A method for reducing the concentration of heavy metal contaminants other than arsenic from an aqueous solution comprising contacting the aqueous solution with a sorption media such that there is sorption of at least a portion of the heavy metal contaminants with the sorption media.

2. The method of claim 1 further comprising separating the sorption media from the aqueous solution.

3. The method of claim 2 wherein the separation of the sorption media from the aqueous media occurs by passing the aqueous media through a column containing the sorption media.

4. The method of claim 2 wherein the separation of the sorption media from the aqueous media occurs by filtration.

5. The method of claim 1 wherein the sorption media is a carbonate mineral.

6. The method of claim 1 wherein the sorption media is a calcium carbonate mineral.

7. The method of claim 6 wherein the calcium carbonate mineral comprises at least about 70% by weight of calcium carbonate particles.

8. The method of claim 5 wherein the carbonate mineral is calcite, aragonite, dolomite, huntite, or vaterite.

9. The method of claim 8 wherein the carbonate mineral is calcite.

10. The method of claim 5 wherein the carbonate mineral comprises at least about 80% by weight of calcite.

11. The method of claim 5 wherein the carbonate mineral is from limestone, chalk, marble, or travertine.

12. The method of claim 5 wherein the carbonate mineral is from limestone, marble, or mixtures thereof

13. The method of claim 12 wherein the carbonate mineral is from limestone.

14. The method of claim 13 wherein the limestone is Minnekahta Limestone, Ste. Genevieve Limestone, Calcite Rock, Sea Aragonite, Minnelusa Limestone, Madison Limestone, or Kentucky Limestone.

15. The method of claim 14 wherein the limestone is Minnekahta Limestone.

16. The method of claim 5 wherein the carbonate mineral comprises at least about 50% by weight of dolomite.

17. The method of claim 6 wherein the particles of calcium carbonate mineral has a density of no less than 1 g/cm³ or a porosity of no greater than 40%.

18. The method of claim 5 wherein the sorption media further comprises at least 0.5% by weight of magnesium carbonate aggregates.

19. The method of claim 18 wherein the calcium carbonate mineral comprises at least about 80% by weight of calcite.

20. The method of claim 18 wherein the calcite is from limestone.

21. The method of claim 18 wherein the magnesium carbonate aggregates are located primarily on the surface of the calcium carbonate particles.

22. The method of claim 18 wherein the magnesium carbonate aggregate is a magnesium carbonate particle.

23. The method of claim 1 wherein the sorption media further comprises at least one binder.

24. The method of claim 23 wherein the binder is a hydraulic cement.

25. The method of claim 24 wherein the binder is Portland cement, modified Portland cement, masonry cement or mixtures thereof.

26. The method of claim 24 wherein the binder is Portland cement.

27. The method of claim 23 wherein the binder is alkaline silicates, silica hydrosol, alumina, silica-alumina, gypsum, plaster of paris, and colloidal clays.

28. A method for reducing the concentration of lead, zinc, chromium, manganese, cadmium, selenium or mercury from an aqueous solution comprising contacting the aqueous solution with a sorption media such that there is sorption of at least a portion of the lead, zinc, chromium, manganese, cadmium, selenium or mercury with the sorption media.

29. The method of claim 28 wherein the concentration of lead, zinc, manganese, cadmium, or mercury is reduced from the aqueous solution.

30. The method of claim 28 wherein the concentration of lead is reduced from the aqueous solution.

31. The method of claim 28 wherein the concentration of mercury is reduced from the aqueous solution.

32. A composition of the sorption media comprising carbonate particles with a sufficient surface area to interact with heavy metal species in solution for efficient heavy metal removal from heavy metal-contaminated or contained solution.

33. The composition of claim 32 wherein the carbonate particles are mineral particles.

34. The composition of claim 32 wherein the mineral carbonate particles are calcium carbonate particles.

35. The composition of claim 32 further comprising aggregates.

36. The composition of claim 35 wherein the aggregates are formed on the calcium particles.

37. The composition of claim 35 wherein the aggregates are magnesium carbonate aggregates.

38. The composition of claim 35 wherein the aggregates are pellets.

39. The composition of claim 35 wherein the aggregates are granules.

40. The composition of claim 32 further comprising a binder.

41. The composition of claim 40 wherein the binder is a cement.

42. The composition of claim 41 wherein the cement is a hydraulic cement.

43. The composition of claim 42 wherein the hydraulic cement is Portland cement.
